(19) United States
(12) Patent Application Publication
(10) Pub. No.: US 2005/0212180 A1
(43) Pub. Date: Sep. 29, 2005

(54) Process for preparation of semi-conducting polymer film containing beta crystalline phase of polyvinylidene fluoride

(75) Inventors: Radhakrishnan Subramaniam, Pune (IN); Swarnendu B. Kar, Pune (IN)

Correspondence Address: DARBY & DARBY P.C., P. O. BOX 5257, NEW YORK, NY, 10150-5257, US

(73) Assignee: Council of Scientific and Industrial Research, New Delhi (IN)

(21) Appl. No.: 10/810,304

(22) Filed: Mar. 26, 2004

(51) Int. Cl. H05B 7/00

(52) U.S. Cl. 264/484; 264/216

(57) ABSTRACT

The present invention provides a process for the preparation of semi-conducting polymer film containing beta crystalline phase of polyvinylidene fluoride with application in piezoelectric devices viz. electro-mechanical sensors, tactile sensors for robotics, touch sensitive switches and the like, and which can be easily made at low temperatures and at low electric fields and having low resistivity/semi-conducting range.

### FIELD OF THE INVENTION

The present invention relates to a process for the preparation of semi-conducting polymer film containing beta crystalline phase of polyvinylidene fluoride. More particularly, this invention provides a process for preparation of polymeric films with high beta crystalline phase of polyvinylidene fluoride at low electric field poling.

### BACKGROUND OF THE INVENTION

Polymers having piezoelectric effect such as polyvinylidene fluoride (PVDF) are important for many areas in industry such as electret microphones, hydrophones, vibration sensing and damping, tactile sensors for robotics, etc. However, PVDF has to be specially treated so as to form the beta crystalline phase, which exhibits the piezoelectric effect. Hence, there have been some efforts made in the past to synthesize polyvinylidene fluoride in beta crystalline phase. Some reports are available in literature (H. S. Nalwa, Ferroelectric Polymers, Marcel Dekker, N.Y, 1995, Ch. 3) which indicate that under certain conditions of high orientation/stretching and high voltage electric field treatment at elevated temperatures (>80° C.) the polyvinylidene fluoride based polymers have predominantly beta phase. These cause many difficulties in processing techniques: the requirements of very high electric fields (>10⁶ V/m) which can cause hazards of electric shocks, the films should have very little defects and high dielectric breakdown strength so that these do not puncture during electric poling and also mechanically the films should withstand stretching operation. Further, such films cannot be easily integrated with electronic devices or circuits. In order to overcome these drawbacks, an alternative process for preparation of beta crystalline polyvinylidene fluoride is necessary. However, there is no prior art for the preparation of beta crystalline phase of polyvinylidene fluoride at low electric field or without mechanical stretching or semi-conducting film containing the same.

### OBJECTS OF THE INVENTION

The main object of the invention is to provide a process for preparation of beta crystalline phase of polyvinylidene fluoride at low temperature, low electric field, without stretching or mechanical deformation and in semi-conducting state.

### SUMMARY OF THE INVENTION

Accordingly, the present invention provides a process for the preparation of semi-conducting polymer film containing beta crystalline phase of polyvinylidene fluoride which comprises dissolving polyvinylidene fluoride in a solvent, dispersing conducting particles therein, casting the dispersed solution on a substrate, evaporating the solvent to obtain a film, drying the film, conditioning the film by holding the film between two metal plates, applying electric potential for a duration of 60 to 300 min, removing the film to give a polymer film containing high beta crystalline phase of polyvinylidene fluoride.

In one embodiment of the invention, the polyvinylidene fluoride used has ethylene content of less than 2%.

In another embodiment of the invention, the solvent used for dissolving and casting films has amide substituted group and has dielectric constant between 20 to 45.

In a further embodiment of the invention, the solvent used is dimethyl acetamide.

In another embodiment of the invention, the conducting particles are selected from the group consisting of particles of polyaniline powder, graphite powder and colloidal silver dispersion in amyl acetate.

In another embodiment of the invention, the conducting particles added to the solution have particle size in the range of 0.1 to 20 micrometers and concentration in the range of 2 to 30%.

In another embodiment of the invention the conducting particles used have conductivity in the range of 10⁻³ to 10⁴ S/cm.

In another embodiment of the invention the film is cast in stainless steel dish at a temperature in the range of 45° to 90° C.

In another embodiment of the invention the electric voltage used for treatment is in the range of 10 V to 100 V.

In another embodiment of the invention the temperature used for conditioning is in the range of 40° C. to 100° C. preferably 80° C.

In a feature of the present invention, the films may be cast by spin coating on smooth substrates and metal electrodes deposited on both sides of the films to form a device directly containing the beta crystalline phase of polyvinylidene fluoride.

### DETAILED DESCRIPTION OF THE INVENTION

The present invention provides a process for the preparation of semi-conducting polymer film containing beta crystalline phase of polyvinylidene fluoride. The process comprises dissolving polyvinylidene fluoride in a solvent which has amide substituted group and has dielectric constant between 20 to 45, such as dimethyl acetamide. Conducting particles such as particles of polyaniline powder, graphite powder or colloidal silver dispersion in amyl acetate is dispersed in this solution and the dispersed solution is then cast in the form of a film. Casting in the form of a film is done by for example casting the dispersed solution on a substrate such as a glass petridish. The solvent is then evaporated to obtain the dispersed solution in the form of a film which is then dried and conditioned by holding the film between two metal plates and applying a electric potential therebetween preferably for a duration in the range of 60 to 300 min. The film is then removed to obtain a polymer film with high beta crystalline phase of polyvinylidene fluoride.

The polyvinylidene fluoride used preferably has ethylene content of less than 2%. The solvent used for dissolving and casting films has amide substituted group and has dielectric constant between 20 to 45. One example of such a solvent is dimethyl acetamide. The conducting particles added to the solution have particle size in the range of 0.1 to 20 micrometers and concentration in the range of 2 to 30%. The conducting particles used have conductivity in the range of 10⁻³ to 10⁴ S/cm. The film can also be cast in a stainless steel dish at a temperature in the range of 45° to 90° C. The electric voltage used for treatment is in the range of 10 V to 100 V and the temperature used for conditioning is in the range of 40° C. to 100° C. preferably 80° C.

In a feature of the present invention, the films may be cast by spin coating on smooth substrates and metal electrodes deposited on both sides of the films to form a device directly containing the beta crystalline phase of polyvinylidene fluoride.

The process of the present invention is described hereinbelow with examples, which are illustrative and should not be construed to limit the scope of the invention in any manner.

### EXAMPLE—1

Polyvinylidene fluoride (0.2 gm) was dissolved in 30 ml dimethyl acetamide at 50° C. to which were then added 0.02 gm of polyaniline powder having conductivity in the range of 1 S/cm and particle size in the rage of 2 to 3 micro meters. The whole mixture was stirred for 24 hrs at R.T to form a uniform conducting polymer blend. This was cast in clean glass petridish by complete solvent evaporation in the 50° C. and then dried under vacuum to give polymer films (30 μm thick). This film was placed between two metal plates, the whole assembly was conditioned at 30° C. and a voltage of 25 V was applied to same for 60 min. The films were cooled and removed from the electrodes and examined for beta crystalline content by x-ray diffraction analysis. The results are indicated in Table—1.

### EXAMPLE—2

0.2 gm. of polyvinylidene fluoride polymer (Aldrich grade) was first dissolved in 30 ml of dimethyl acetamide at 50° C. and then 0.03 gm of graphite powder (particle size 5 to 7 μm) with conductivity of 100 S/cm was added to same to get semiconducting composition. The solution was stirred for 24 hrs at 30° C. to form a uniform polyvinylidene fluoride—graphite dispersion. This was cast in clean glass petridish followed by complete solvent evaporation in the 50° C. and then dried under vacuum to give polymer films (30 μm). This film was subjected to electrical poling treatment as follows. The film was placed between two aluminum foil electrodes (1 cm×1 cm.) to which electrical wires were attached for application of voltage. The temperature was raised to 80° C. and a voltage of 100 V was applied for 3 hr. The films were cooled and removed from the electrodes and examined for beta crystalline content by x-ray diffraction analysis. The results are indicated in Table—1.

### EXAMPLE 3

0.2 gm of PVDF polymer was first dissolved in 30 ml. of dimethyl acetamide at 50° C. and then 0.06 gm of colloidal silver dispersion in amyl acetate (particle size 2-3 μm) was added to get 30% blend composition. The solution was stirred for 24 hrs at 25° C. to form an uniform slurry. This was cast in clean glass petridish followed by complete solvent evaporation in the 50° C. and then dried under vacuum for 24 hrs to give a polymer film (30 μm). This film was subjected to electrical poling treatment as follows. The film was placed between two aluminum foil electrodes (1 cm×1 cm.) to which electrical wires were attached for application of voltage. The temperature was raised to 80° C. and a voltage of 100 V was applied for 3 hr. The films were cooled and removed from the electrodes and examined for beta crystalline content by x-ray diffraction analysis. The results are indicated in Table—1.

TABLE 1
The Beta Crystalline Phase Content in the Polymer Films

| | | Beta | |
|---|---|---|---|
| | | Crystalline | Electrical |
| | Electric Poling | phase content | conductivity |
| Polymer film | Conditions | (%) | (ohm-cm)⁻¹ |
| Example-1 | Room | 43 | 2.7 × 10⁻⁴ |
| | Temperature, | | |
| | 25 V | | |
| Example-2 | 80° C., 100 V | 47 | 1.1 × 10⁻³ |
| Example-3 | 80° C., 100 V | 49 | 1.0 × 10⁻³ |
| Polyvinylidene fluoride | 80° C., 100 V | 0 | 1.3 × 10⁻¹³ |
| film cast from dimethyl | | | |
| acetamide without | | | |
| additive and as | | | |
| such | | | |

*Beta crystalline content determined from the intensity of X-ray diffraction peak at 2 θ of 20.4 (±0.1) degrees.

It can be seen by comparing the results given in the above Table—1 that the polymer film prepared by the process described in the present invention has high beta crystalline phase content than otherwise. It can also be observed that these films are semi-conducting as compared to the normal insulating polyvinylidene fluoride.

The main advantage of the present invention is that it provides a simple and safe method of preparation of polymer film having beta crystalline phase of polyvinylidene fluoride using low voltages and which can be directly applied on different substrates by solution coating. Further, the polymer film can be easily made into device or integrated with other devices without the need for mechanical deformation or bonding with adhesives.

The polymeric films obtained in the present invention have a large number of applications such as for example, in piezoelectric devices viz. electromechanical sensors, tactile sensors for robotics, touch sensitive switches etc. The beta crystalline phase of polyvinylidene fluoride alone has piezoelectric properties. However, in order to generate this crystalline phase the polymer has to be processed in certain conditions—it has to be poled under high electric field in excess of 10⁶V/m, high temperature (80 to 120 C), it has to be mechanically stretched/oriented etc. Further, it has very high electrical resistivity which makes it difficult to connect to conventional electronic circuits. The process of the present invention overcomes these drawbacks and provides a process for preparation of polymer film containing beta crystalline phase of polyvinylidene fluoride, which can be easily made at low temperatures and at low electric fields and having low resistivity/semi-conducting range.

1. A process for the preparation of semi-conducting polymer film containing beta crystalline phase of polyvinylidene fluoride which comprises dissolving polyvinylidene fluoride in a solvent, dispersing conducting particles therein, casting the dispersed solution on a substrate, evaporating the solvent to obtain a film, drying the film, conditioning the film by holding the film between two metal plates, applying electric potential for a duration of 10 to 300 min, removing the film to give a polymer film containing high beta crystalline phase of polyvinylidene fluoride.

2. A process as claimed in claim 1 wherein the polyvinylidene fluoride used has ethylene content of less than 2%.

3. A process as claimed in claim 1 wherein the solvent used for dissolving and casting films has amide substituted group and has dielectric constant between 20 to 45.

4. A process as claimed in claim 1 wherein the solvent used is dimethyl acetamide.

5. A process as claimed in claim 1 wherein the conducting particles are selected from the group consisting of particles of polyaniline powder, graphite powder and colloidal silver dispersion in amyl acetate.

6. A process as claimed in claim 1 wherein the conducting particles added to the solution have particle size in the range of 0.1 to 20 micrometers and concentration in the range of 2 to 30%.

7. A process as claimed in claim 1 wherein the conducting particles used have conductivity in the range of 10⁻³ to 10⁴ S/cm.

8. A process as claimed in claim 1 wherein the film is cast in stainless steel dish at a temperature in the range of 45° to 90° C.

9. A process as claimed in claim 1 wherein the electric voltage used for treatment is in the range of 10 V to 100 V.

10. A process as claimed in claim 1 wherein the temperature used for conditioning is in the range of 40° C. to 100° C.

11. A process as claimed in claim 1 wherein the temperature used for conditioning is 80° C.

12. A process as claimed in claim 1 wherein the film is cast by spin coating on a smooth substrate with metal electrodes deposited on both sides of the film to form a device directly containing the beta crystalline phase of polyvinylidene fluoride.

13. A process as claimed in claim 1 wherein the concentration of the conducting particles ranges from 3% to 50% of the polymer.

14. A process as claimed in claim 13 wherein the concentration of the conducting particles is 20% by weight of the polymer.

15. A process as claimed in claim 1 wherein the time for application of electric voltage is in the range of 10 min to 300 min preferably 60 min.
